(19) United States
(12) Patent Application Publication
(10) Pub. No.: US 2025/0389473 A1
(43) Pub. Date: Dec. 25, 2025

(54) REFRIGERATOR AND REFRIGERATOR DOOR UPGRADE KIT

(71) Applicant: LG ELECTRONICS INC., Seoul (KR)

(72) Inventors: Seonyong JANG, Seoul (KR); Yonghyun CHO, Seoul (KR)

(21) Appl. No.: 18/879,326

(22) PCT Filed: May 16, 2023
(86) PCT No.: PCT/KR2023/006648

§ 371 Date: Dec. 27, 2024

(30) Foreign Application Priority Data
Jun. 27, 2022 (KR) 10-2022-0078337

(51) Int. Cl. F25D 23/02; F21V 23/00; F21V 23/04; F21V 33/00; F21W 131/305

(52) U.S. Cl. CPC F25D 23/028; F21V 23/001; F21V 23/003; F21V 23/0464; F21V 33/0044; F21W 2131/305

(57) ABSTRACT

The present invention relates to a refrigerator comprising: a cabinet forming a storage space; doors for opening/closing the cabinet; and a door upgrade kit that can be detachably mounted in order to improve the performance of the doors, wherein the door upgrade kit includes: a panel assembly which is mounted on the door so as to form the exterior of the front of the door, and which has a lighting device for illuminating the front of the door in set colors; and a main controller, which is provided at the cabinet and controls the operation of the refrigerator and the lighting device.

### TECHNICAL FIELD

The present disclosure relates to a refrigerator and a refrigerator door upgrade kit.

### BACKGROUND ART

In general, home appliances are disposed indoors and can be disposed so as to be in harmony with the surrounding space. In addition, in order to further improve an outer appearance of these home appliances, a panel forming the outer appearance can be provided on the front surface of the home appliance.

For example, refrigerators are being developed with structures that vary the outer appearance of the front surface to ensure harmony with the environment in which the refrigerators are disposed, surrounding furniture, or other home appliances, and this trend is being followed across home appliances.

In U.S. Pat. No. 8,789,900, a structure in which a decorative panel forming an outer exterior appearance is mounted on the front surface of a refrigerator door is disclosed, and the decorative panel is configured to be detachable so that the outer appearance of the front surface of the door can be formed according to the user's preference.

However, in a refrigerator with this type of structure, if the user wants to change the outer appearance, the entire decorative panel must be removed and replaced, and there is a problem in that the decorative panel before replacement can no longer be used.

To solve this problem, in Chinese patent No. 103250018, a refrigerator is disclosed in which a reflective layer and a transparent panel are provided on the front surface of the refrigerator door, and in which a colored light-emitting member is mounted on both ends of the reflective layer to cause the transparent panel to glow in a set color.

Meanwhile, users who have already purchased an existing refrigerator must purchase a new one if they want to use a refrigerator with a door front surface that glows. In this case, there is a problem in that the cost burden on the user increases, and resources are wasted as the existing refrigerator has to be disposed of.

### DISCLOSURE

### Technical Problem

An object of an embodiment of the present disclosure is to provide a refrigerator and a refrigerator door upgrade kit that allows the front surface of the door to glow in a set color simply by replacing the door and some parts of an existing refrigerator without a new purchase.

An object of an embodiment of the present disclosure is to provide a refrigerator and a refrigerator door upgrade kit that is easy to assemble and allows for door replacement at low cost.

### Technical Solution

A refrigerator and a refrigerator door upgrade kit according to one embodiment of the present disclosure are configured to replace an existing refrigerator door with a door equipped with a lighting device, so that the outer appearance of the door can glow in a set color at a low cost without a new purchase.

A refrigerator according to an embodiment of the present disclosure may include a cabinet forming a storage space; a door opening and closing the cabinet; and a door upgrade kit detachably mounted to improve the performance of the door, in which the door upgrade kit may include a panel assembly mounted on the door to form an outer appearance of a front surface of the door and having a lighting device that causes the front surface of the door to glow in a set color; and a main controller provided in the cabinet and controlling the operation of the refrigerator and the lighting device.

The door upgrade kit may include an LED controller that controls the light sources placed in the lighting device, and the main controller may be connected to the LED controller and controls the lighting device to glow in a set color.

The door upgrade kit may include an electric wire connecting the lighting device, the main controller, and the LED controller.

A plurality of doors and a plurality of lighting devices may be provided, and the lighting devices provided on the plurality of doors may be connected to the LED controller provided as a single configuration in the cabinet by the electric wires.

The electric wires may be disposed along an upper surface, a lower surface, and a rear surface of the cabinet, and guided to the lighting device inside the door through an upper hinge and a lower hinge connected to an upper end and a lower end of the door.

The door upgrade kit may include an electric wire transmitting power and operating signals to the lighting device; and a cover assembly disposed on an upper surface of the cabinet, and the electric wires may be guided through the cover assembly.

The cover assembly may include a hinge cover provided on the upper surface of the cabinet and shielding a hinge device that rotatably connects to the door, and the hinge cover may accommodate the electric wires and the LED controller.

The cover assembly may include a side cover provided on both left and right sides of the upper surface of the cabinet and extending from a front end to a rear end of the cabinet to guide the electric wires toward the rear surface of the cabinet.

The side cover may be connected to the hinge cover.

The door may further include a door body having the panel assembly detachably mounted thereon and having insulation material filled therein; the panel assembly may include a panel forming the outer appearance of the front surface of the door and through which light is transmitted; a light guide plate disposed at the rear of the panel and guiding light irradiated from the lighting device toward the panel; and a back cover forming a rear surface of the panel assembly.

The main controller may receive color information set by the user from a remote device and control the lighting device so that the panel glows in a color set by the user.

The door upgrade kit may further include a microphone module into which the user's voice is input, and the main controller may turn on the lighting device or controls the intensity of the light output by voice input through the microphone module.

The door upgrade kit may further include a user detection device for detecting user approach; and the main controller turn on the lighting device or controls the output according to detection of the user detection device.

The door upgrade kit may further include a light sensing device that detects the brightness of the surrounding environment, and the main controller may control the output of the lighting device according to detection of the light sensing device.

The door upgrade kit may include electric wires to power and transmit signals to the lighting device; at least a part of the electric wire may be guided from the upper surface of said cabinet to the rear surface of said cabinet, and the electric wire guided to the rear surface of the cabinet may be guided along the lower surface of the cabinet and connected to the lighting device.

A door assembly kit according to an embodiment of the present disclosure may include a panel assembly mounted on a door that opens and closes a storage space in a cabinet, forming an outer appearance of a front surface of said door and having a lighting device that illuminates in a set color; a main controller provided in the cabinet and controlling the operation of the refrigerator and the lighting device; an electric wire connecting the main controller and the lighting device to transmit power and operation signals; and a cover assembly disposed in the cabinet and having the electric wires accommodated therein, in which the panel assembly may be detachably mounted on the front surface of the door, and the controller and cover assembly are detachably mounted on an outer appearance of the cabinet, such that the front surface of the door glows in a set color.

### Advantageous Effect

The refrigerator according to the proposed embodiment can be expected to have the following effects.

According to an embodiment of the present disclosure, there is an advantage in that the panel forming the front surface of the door can be replaced with a panel equipped with a lighting device, thereby allowing the front surface of an existing refrigerator to glow in a set color.

According to an embodiment of the present disclosure, there is an advantage in that the existing refrigerator can have the same functions as the new refrigerator by allowing the user to replace the existing door with a door equipped with a lighting device without purchasing a new refrigerator.

### DESCRIPTION OF DRAWINGS

FIG. 1 is a perspective view illustrating a refrigerator not equipped with a door upgrade kit according to one embodiment of the present disclosure.

FIG. 2 is a perspective view illustrating a refrigerator equipped with a door upgrade kit according to one embodiment of the present disclosure.

FIG. 3 is a perspective view illustrating a door according to one embodiment of the present disclosure.

FIG. 4 is an exploded perspective view illustrating a state where the panel assembly and the door body constituting the door are separated.

FIG. 5 is an exploded perspective view illustrating a panel assembly viewed from the front according to one embodiment of the present disclosure.

FIG. 6 is an exploded perspective view illustrating the coupled structure of the lower bracket, lighting device, and light supporter which are configuration of the panel assembly.

FIG. 7 is a view for explaining the components of a door upgrade kit according to one embodiment of the present disclosure.

FIG. 8 is a simplified view illustrating the electric wiring layout of a refrigerator with a door upgrade kit applied, viewed from one side.

FIG. 9 is a simplified view illustrating the electric wiring layout of a refrigerator with a door upgrade kit applied, viewed from below.

FIG. 10 is a block diagram illustrating the control signal flow of a refrigerator with a door upgrade kit applied.

### BEST MODE

Hereinafter, specific embodiments of the present disclosure will be described in detail with reference to the drawings. However, the present disclosure is not limited to the embodiments in which the idea of the present disclosure is presented, and other regressive disclosures or other embodiments included within the scope of the idea of the present disclosure can be easily proposed by adding, changing, deleting, or the like other components.

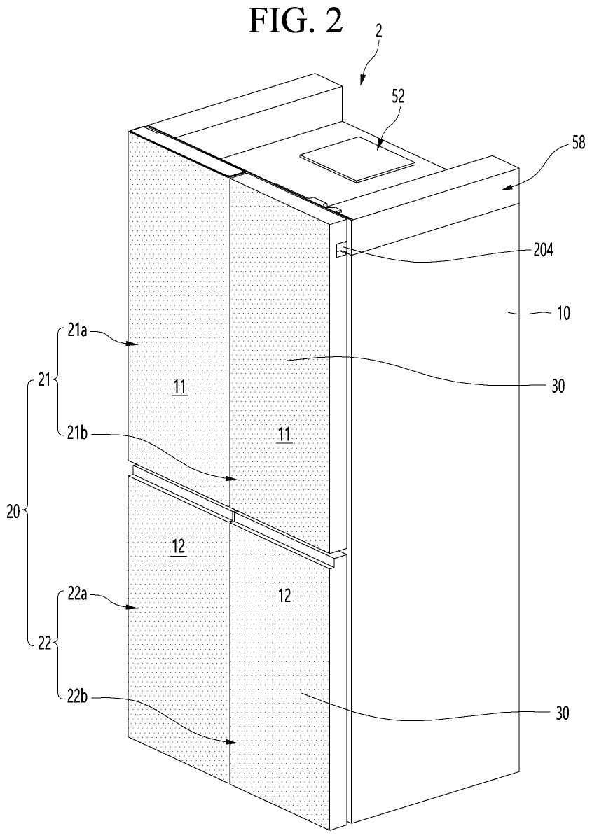

Before explanation, the direction is defined. In an embodiment of the present disclosure, the direction toward the door based on the cabinet illustrated in FIG. 2 can be defined as front, the direction toward the cabinet based on the door can be defined as rear, the direction toward the floor surface on which the refrigerator is installed can be defined as downward, and the direction away from the floor surface can be defined as upward.

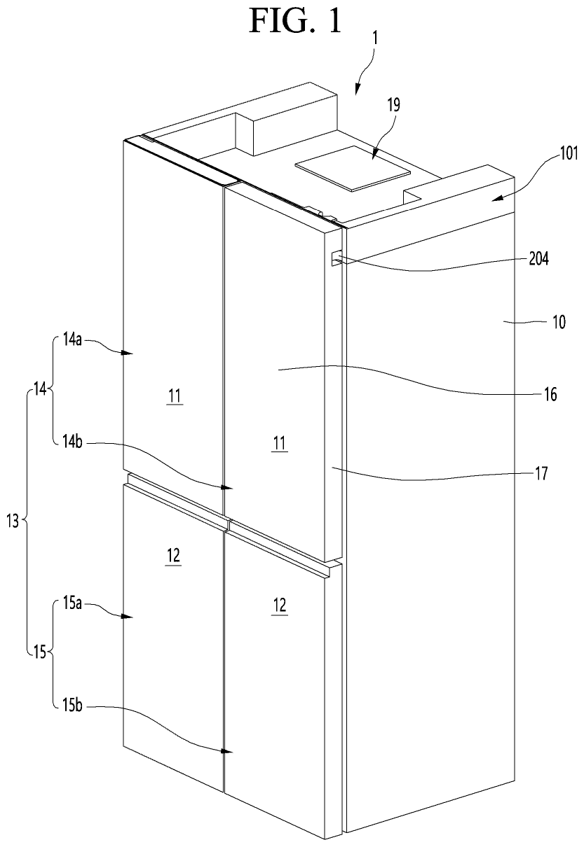

FIG. 1 is a perspective view illustrating a refrigerator not equipped with a door upgrade kit according to one embodiment of the present disclosure, and FIG. 2 is a perspective view illustrating a refrigerator equipped with a door upgrade kit according to one embodiment of the present disclosure.

According to one embodiment of the present disclosure, a door upgrade kit can be applied to change an existing refrigerator into a refrigerator in which the front surface of the door can glow in a set color.

For example, a refrigerator being used by a user may be a refrigerator whose the color of the front surface of the door does not change, as illustrated in FIG. 1. This refrigerator being used is defined as a first refrigerator.

The first refrigerator 1 can have an outer appearance formed by a cabinet 10 forming a storage space and a door 13 for opening and closing the storage space of the cabinet 10.

For example, the cabinet 10 may form a storage space divided into upper and lower parts, with a refrigerating compartment 11 formed at the upper part and a freezing compartment 12 formed at the lower part. The refrigerating compartment 11 may be referred to as an upper storage space, and the freezing compartment 12 may be referred to as a lower storage space.

The door 13 can be configured to open and close the refrigerating compartment 11 and the freezing compartment 12, respectively. For example, the door 20 can be rotatably mounted on the cabinet 10 by being connected by a hinge device 204, 205, and can open and close the refrigerating compartment 11 and the freezing compartment 12, respectively, by rotation. The hinge device 204, 205 is connected to the upper part of the door, so that the hinge device can be referred to as an upper hinge. Of course, the door 20 may have a structure that opens and closes by pulling in and out.

A pair of upper doors 14 may be provided on the left and right, and configured so that the refrigerating compartment 11 is shielded by the pair of doors.

The pair of upper doors 14 may be disposed, with a left upper door 14a and a right upper door 14b disposed side by side. The left upper door 14a and the right upper door 14b can be rotated independently to open and close the refrigerating compartment.

A pair of lower doors 15 may be provided on the left and right, and configured to open and close the freezing compartment 12 by the pair of doors.

The pair of lower doors 15 may be also disposed with a left lower door 15a and a right lower door 15b disposed side by side. The left lower door 15a and the right lower door 15b can be rotated independently of each other to open and close the freezing compartment 12.

Of course, the lower door 15 may be configured to be capable of being pulled in and out in a drawer-like manner as needed, and may be configured with one or more doors.

In this embodiment, for the convenience of explanation and understanding, a refrigerator having a structure in which a refrigerating compartment 11 is disposed at the top and a freezing compartment 12 is disposed at the bottom is described as an example, but the present disclosure is not limited to the shape of the refrigerator and can be applied to all types of refrigerators equipped with doors.

Meanwhile, the door 13 can form the outer appearance of the front surface of the refrigerator 1 when closed. In other words, the door 13 can form the outer appearance of the refrigerator 1 that is visible from the front when the refrigerator 1 is installed.

Hereinafter, the door provided in the first refrigerator 1 is defined as the first door.

For example, the first door 13 may include an outer plate forming an outer appearance and a door liner mounted spaced apart from the outer plate.

The outer plate may be formed of a plate-shaped stainless steel material. The front surface of the outer plate may be subjected to various surface treatments, such as an anti-fingerprint coating, a hairline, a coating for implementing color or pattern, or attachment of a film.

In addition, the upper end and lower end, and both sides of the outer plate can be bent. In addition, between the outer plate and the door liner, the upper cap decoration and Lower cap decoration are provided so that the upper and lower surfaces of the door can be formed.

As another example, the first door 13 may include a panel assembly 16 provided on the front surface of the door 13 to form an outer appearance of the door and a door body 17 on which the panel assembly 16 is mounted.

The door body 17 has a predetermined thickness and is filled with insulating material inside to insulate the storage space.

The first panel assembly 16 can be mounted on the front surface of the door body 17 to form the outer appearance of the front surface of the door 13 and the refrigerator 1.

The first panel assembly 16 can be easily detachably mounted on the door body 17. In addition, even when the door 13 is mounted on the cabinet 10, the panel assembly 16 can have a structure that allows for easy detachment. Accordingly, a user can mount or exchange a panel assembly 16 of a desired design as needed.

The door body 17 may include a body plate 171 as a whole and a side frame 172 forming a door side. An upper cap decoration 181 and a lower cap decoration 182 may be provided on the upper and lower surfaces of the door body 17.

The first panel assembly 16 may include a plate-shaped panel 161 forming an outer appearance and a first bracket and a second bracket for fixing the upper and lower ends of the panel 161.

The panel 161 may be formed of a rectangular plate-shaped material having a predetermined thickness, and may be formed of a material that can be in harmony with the furniture, walls, or home appliances placed around the panel. For example, the panel 161 may be formed of a glass material.

For example, the panel 161 may be formed of a glass material, and may be formed to have the outer appearance of the door 13 by printing or attaching a film to have a color or pattern.

The panel assembly 16 may be fixed to the door body 17 using a magnet, adhesive, or the like.

Meanwhile, the first refrigerator 1 includes a control part 19 for controlling the overall operation of the refrigerator. The control part 19 may be provided on the upper surface of the cabinet 10.

According to one embodiment of the present disclosure, by applying a door upgrade kit, a first refrigerator 1 can be changed into a refrigerator whose a front surface of the door glows in a set color. Hereinafter, a refrigerator to which a door upgrade kit is applied is defined as a second refrigerator.

For example, a second refrigerator 2 to which a door upgrade kit 5 is applied may be provided with a lighting device 36 inside the door. Light emitted from the lighting device 36 may pass through the front surface of the door, causing the front surface of the door to glow in a set color.

The door upgrade kit 5 includes a second door 20 equipped with the lighting device 36. In addition, the door upgrade kit 5 may include a main controller. The main controller 52 may control the overall operation of the second refrigerator 2 and control the lighting device 36 to cause the front surface of the door to glow in a color set by the user. In addition, the door upgrade kit 5 may further include electric wires or the like for connecting the lighting device 36 and electrical components.

In detail, the second refrigerator 2 may have the same disposition as the cabinet 10 and the first door 13 of the first refrigerator 1 described above. In addition, the second refrigerator 2 includes a second door 20 having a lighting device 36 provided inside the door.

The second door 20 may have a size and shape corresponding to the first door 13 so as to be replaceable with the first door 13.

In addition, the user can mount a main controller 52 for controlling an electric wire and a lighting device 36 electrically connected to the second door 20 on the cabinet 10.

In other words, the user can change the first refrigerator 1 currently in use into a second refrigerator 2 by purchasing a door upgrade kit including a second door 20. In other words, the user can make the first refrigerator 1 implement the same function as the second refrigerator 2 by purchasing only the door upgrade kit without purchasing a new second refrigerator whose front door can glow in a color desired by the user.

Below, the second door equipped with a lighting device that constitutes the door upgrade kit is described in detail.

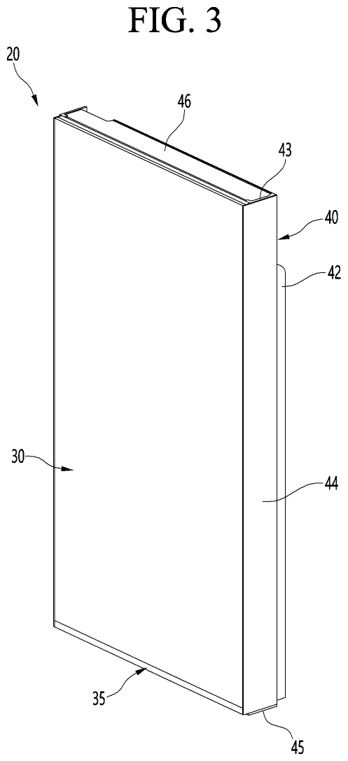

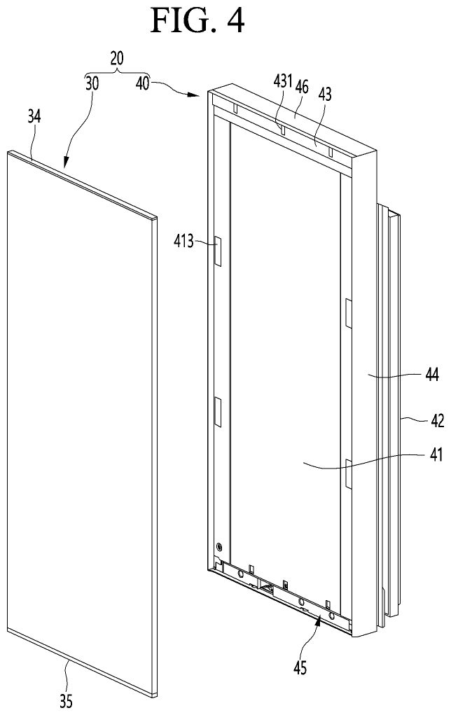

FIG. 3 is a perspective view illustrating a door according to one embodiment of the present disclosure, and FIG. 4 is an exploded perspective view illustrating a state where the panel assembly and the door body constituting the door are separated.

As illustrated, the second door 20 forms the overall shape of the door 20 and may include a door body 40 that opens and closes the storage space and a panel assembly 30 that forms the outer appearance of the front surface of the door 20. In other words, the door 20 may be configured such that the panel assembly 30 is mounted on the front surface of the door body 40.

The door body 40 may include a body plate 41 forming the front surface and a door liner 42 forming the rear surface. The body plate 41 may be disposed to face the rear surface of the panel assembly 30. In addition, the door liner 42 may form the shape of the rear surface of the door 20.

The door body 40 may include side decorations 44 forming left and right sides of the door body 40. The side decorations 44 may connect both left and right sides of the body plate 41 and both left and right sides of the door liner 42.

In addition, the door body 40 may include an upper cap decoration 43 and a lower cap decoration 45 forming the upper and lower surfaces of the door body 40.

Meanwhile, the panel assembly 30 can be inserted and mounted on the front surface of the door body 40. For example, the side decoration 44 and the lower cap decoration 45 can protrude further forward and can come into contact with both ends and the lower end of the panel assembly 30.

The panel assembly 30 is formed in a plate shape and can form the outer appearance of the front surface of the door 20 when mounted on the front surface of the door body 40.

The panel assembly 30 forms the outer appearance of the front surface of the second door 20, so the panel assembly may also be referred to as a door panel or an exterior panel.

The panel assembly 30 can be detachably mounted on the door body.

The panel assembly 30 can be detachably mounted on the door body. The lower end of the panel assembly 30 is supported on the lower cap decoration 45, and an upper protrusion is formed on the upper end of the rear surface of the panel assembly 30 so that it can be inserted and mounted on the upper mounting portion 431 on the front surface of the door body 40.

In addition, a connector hole may be formed on the front surface of the lower cap decoration, through which an electric wire connected to a lighting device provided inside the panel assembly 30 passes. In addition, a connector connected to the electric wire may be disposed inside the connector hole. A connector corresponding to the end part of the electric wire may be provided so as to be detachable from the connector. With this structure, the electric wire may be easily connected and disconnected when the panel assembly 30 is detached.

In this way, the panel assembly 30 may have a structure that can be detachably mounted from the door body 40 for service and maintenance.

The panel assembly 30 is exposed forwardly when mounted on the door body 40, and can form a substantial outer appearance of the front surface of the door 20. In other words, the color of the outer appearance of the front surface of the second door 20 can be determined by the color of the front surface of the panel assembly 30. In addition, the entire front surface of the panel assembly 30 can be configured to glow in a color designated by the user, and when the second door 20 and the panel assembly 30 are mounted, the color of the front surface of the door 20 can be changed to various colors selected by the user, thereby expressing various colors.

Below, the structure of the panel assembly 30 constituting the second door 20 will be examined in detail with reference to the drawings.

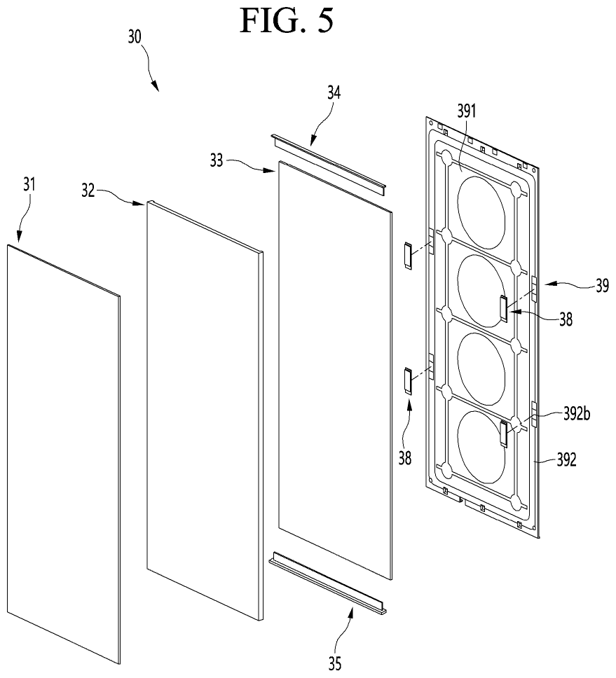

FIG. 5 is an exploded perspective view illustrating a panel assembly viewed from the front according to one embodiment of the present disclosure.

A panel assembly 30 according to one embodiment of the present invention may include a panel 31 forming an outer appearance of the front surface, and a lighting device 36 that irradiates light so that the panel 31 glows. In addition, the panel assembly 30 may include a light guide plate 33 that guides light irradiated from the lighting device 36 and a back cover 39 that forms an outer appearance of the rear surface of the panel assembly 30.

In addition, the panel assembly 30 may further include a fixing member 32 for mounting the light guide plate 33 and the panel 31.

In addition, the panel assembly 30 may further include an upper bracket 34 forming an upper surface of the panel assembly 30 and a lower bracket 35 forming a lower surface of the panel assembly 30.

The lighting device 36 can be mounted on the lower bracket 35.

The panel 31 may be formed in a rectangular plate shape and may be formed of a transparent material that allows light to pass through. For example, the panel 31 may be formed of a glass material or another material that allows light to pass through.

In addition, the panel 31 can be formed to have a color. The panel 31 can be configured so that light irradiated from the lighting device 36 is transmitted through the panel 31 but the components behind the panel 31 are not illuminated.

The panel 31 can be mounted on the front surface of the fixing member 32.

The light guide plate 33 may be positioned at the rear, spaced apart from the panel 31, and may be configured to guide light irradiated from a lighting device 36 disposed below the light guide plate 33 forward toward the panel 31. A reflective layer may be formed on the rear surface of the light guide plate 33 to direct light inside the light guide plate 33 forward.

A fixing member 32 may be provided between the panel 31 and the light guide plate 33.

The fixing member 32 can have its front surface in contact with the panel 31 and its rear surface in contact with the light guide plate 33. In addition, the side part can provide a structure in which the light guide plate 33 can be fixed and the upper bracket 34, lower bracket 35 and back cover 39 can be mounted.

In addition, the back cover 39 can form the rear surface of the panel assembly 30.

The back cover 39 may include a cover protrusion 391 at the center of the back cover 39 and a cover perimeter 392 formed along the periphery of the cover protrusion 391, and the cover protrusion 391 and the cover perimeter 392 may be formed by forming.

A fixing member opening 392b in which a panel fixing member 38 is installed may be formed on both left and right sides of the cover perimeter 392. The panel fixing member 38 may be fixed to the back cover 39 and may be protruded rearward to be coupled to the fixing member coupled part 413 on the front surface of the door body 40.

Meanwhile, the panel assembly 30 constituting the second door 20 can have the lighting device 36 mounted on the lower bracket 35.

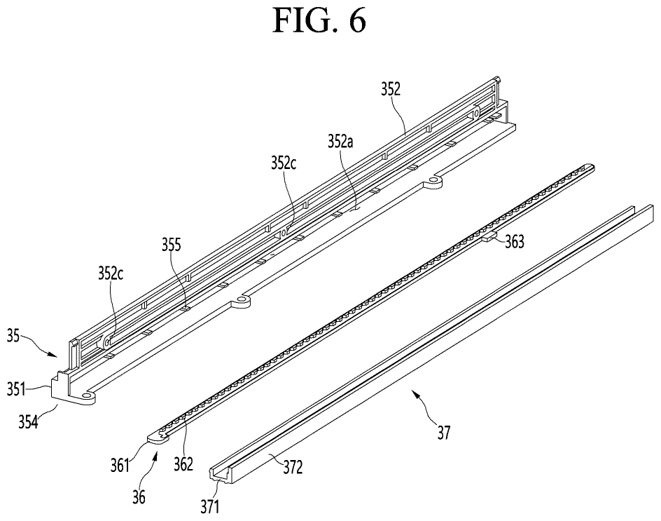

FIG. 6 is an exploded perspective view illustrating the coupled structure of the lower bracket, lighting device, and light supporter which are configuration of the panel assembly.

The lower bracket 35 may include a lower bracket front part 351 and a lower bracket rear part 352, a lower bracket side part 353 and a lower bracket lower part 354.

The upper end of the lower bracket front part 351 can support the lower end of the panel 31. In addition, the lower bracket rear part 352 can protrude upwards further than the lower bracket front part 351 and lower bracket side part 353 to support the light guide plate 33 from the rear and can be coupled with the back cover.

A lower bracket screw hole 352c to which a number of screws are fastened is formed on the lower bracket rear part 352, thereby providing a structure that can be coupled with the back cover 39.

Meanwhile, the lower bracket rear part 352 may have a bracket opening 352a. The lighting device 36 can be entered and exited through the bracket opening 352a.

The lower bracket lower part 354 can form the floor surface of the space where the lighting device 36 is mounted.

Meanwhile, a plurality of light guide plate support parts 355 that support the lower end of the light guide plate 33 may be formed on the lower bracket 35. The lower end of the light guide plate 33 may be supported by the light guide plate support members 355 to maintain a gap with the lighting device 36.

Meanwhile, a lighting device 36 may be provided inside the lower bracket 35. The lighting device 36 may include a substrate 361 and a light source 362 The substrate 361 is accommodated inside the lower bracket 35, and a plurality of light sources 362 may be disposed in series at regular intervals on the substrate 361.

The light source 362 may be disposed so as to irradiate light toward the lower end of the light guide plate 33. The light source 362 may be composed of an LED, for example. In addition, the light source 362 can be composed of an RGB light source that can irradiate light of various colors according to the control of the control part provided in the refrigerator 1. In other words, the light source 362 can irradiate light of various colors according to the user's manipulation, and thus the panel 31 can glow in a color set by the user. In addition, the color of the outer appearance of the front surface of the refrigerator 1 can be determined according to the color of the panel 31.

A substrate connection part 363 protruding rearwardly may be formed on one side of the substrate 361, and an electric wire may be connected to the substrate connection part 363. The substrate connection part 363 may be protruded so as to be exposed through an electric wire entrance 398 formed in the back cover 39, and the electric wire may be entranced and exited through the electric wire entrance 398.

Meanwhile, a light supporter 37 may be provided at the bottom of the substrate 361. The light supporter 37 may include a horizontal part 371 and a vertical part 372. The horizontal part 371 forms the lower surface of the light supporter 37 and may be disposed at the bottom of the substrate 361 to support the substrate 361.

With this structure, when the light source of the lighting device 36 is turned on, it is guided to the front surface of the panel assembly 30 by the light guide plate 33, so that the front surface of the door 20 can be glowed.

In addition, the second refrigerator 2 can have an outer appearance thereof formed by the panel assembly 30, and the outer appearance can be changed to a color set by the user according to the operation of the lighting device 36.

In detail, the color of the outer appearance of the front surface of the second refrigerator 2 can be expressed by the color of the panel 31 itself when the lighting device 36 is turned off. The color displayed on the panel 31 when the lighting device 36 is turned off can be referred to as the first color.

When the lighting device 36 is operated, the color of the panel 31 changes according to the color of the light irradiated from the lighting device 36, and the color of the outer appearance of the front surface of the door 20 can be expressed as a selected color. At this time, the color displayed through the panel by the light irradiated from the lighting device 36 can be referred to as a second color.

For example, the lighting device 36 can be manipulated and set via a remote device that is separate from the refrigerator 2. The refrigerator 2 can communicate with the remote device via a communication part 17 connected to the control part, and a user can manipulate the operation of the lighting device 36 via the remote device.

The communication part 17 can communicate with the remote device in various ways. For example, the remote device can be various devices capable of communication, such as a dedicated terminal, a mobile phone, a tablet, a portable PC, a desktop PC, a remote control, a Bluetooth speaker, or the like.

The user can manipulate and set the overall operation status of the lighting device 36, such as the operation time, operation conditions, and light source emission color of the lighting device 36, through the manipulation of the remote device. For example, the simple manipulation and setting of the lighting device 36 may be possible through an application or dedicated program installed on the user's mobile phone. In other words, the user can select a desired panel 31 color through the screen 2a of a remote device, such as a mobile phone or terminal.

Additionally, the user can input a color through the manipulation part provided in the refrigerator 2 without using the remote device.

In addition, the second refrigerator 2 and the remote device can be connected to the server in a network state, and therefore, the color of the panel 31 of the second refrigerator 2 can be input through the server.

The second refrigerator 2 may be equipped with a microphone that receives a user's voice. Then, the user's voice received from the microphone can be recognized, and the operation of the lighting device 36 can be controlled according to the user's voice command.

In addition, the second refrigerator 2 may be equipped with a speaker module 57. The speaker module 57 may be configured as a Bluetooth speaker that can be connected to the remote device. The user may control the Bluetooth speaker through the remote device so that a song desired by the user is output. In addition, the lighting device 36 may control the intensity, i.e., brightness, output from the light source of the lighting device 36 according to the intensity of the sound source output through the speaker module 57.

Hereinafter, a door upgrade kit according to one embodiment of the present disclosure is described in detail.

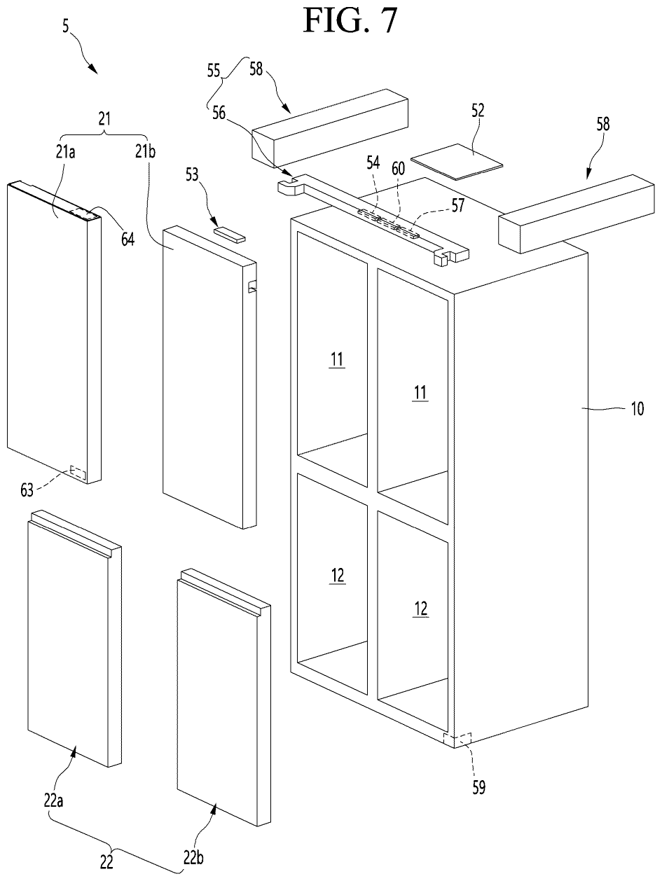

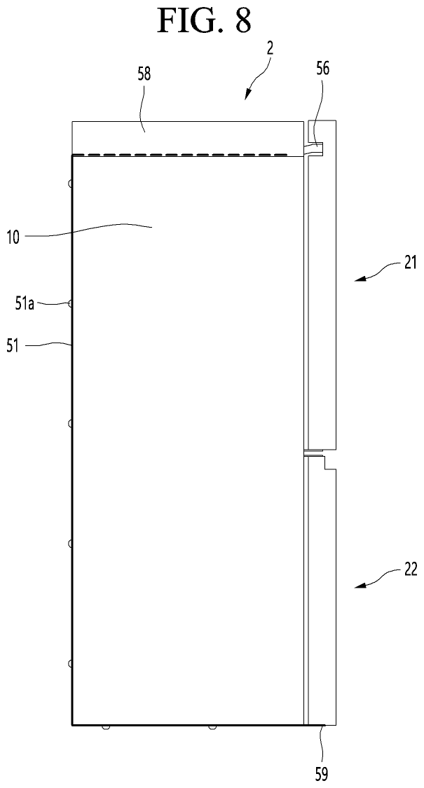

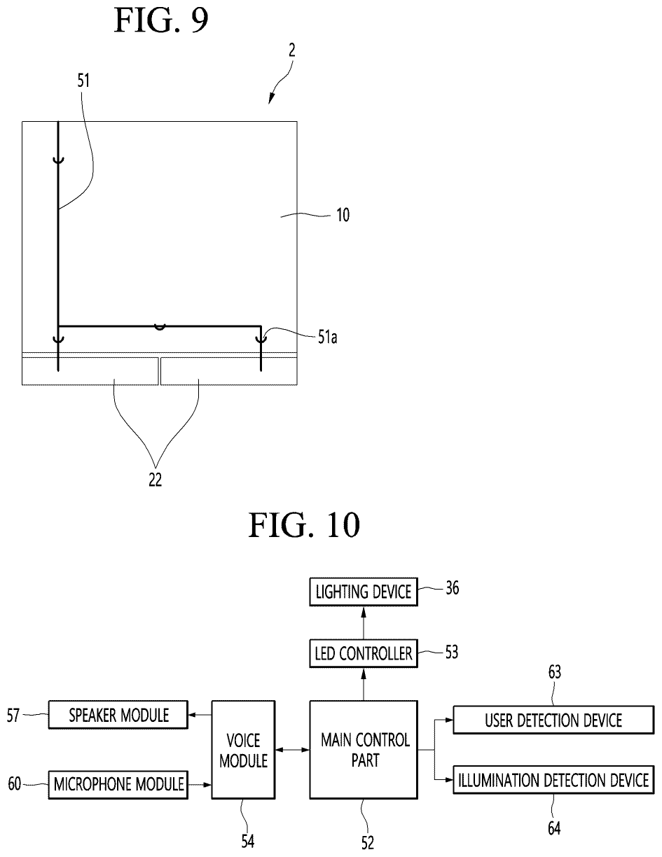

FIG. 7 is a view for explaining the components of a door upgrade kit according to one embodiment of the present disclosure, FIG. 8 is a simplified view illustrating the electric wiring layout of a refrigerator with a door upgrade kit applied, viewed from one side, FIG. 9 is a simplified view illustrating the electric wiring layout of a refrigerator with a door upgrade kit applied, viewed from below, and FIG. 10 is a block diagram illustrating the control signal flow of a refrigerator with a door upgrade kit applied.

Before the explanation, the door equipped in the first refrigerator 1 that the user is currently using is referred to as the first door 13. In addition, the panel assembly that constitutes the first door 13 is referred to as the first panel assembly 16. In addition, the door body on which the first panel assembly 16 is mounted can be referred to as the first body 17.

In addition, a door having a lighting device 36 installed inside the door upgrade kit 5 is referred to as a second door 20. In addition, a panel assembly 30 having the lighting device 36 mounted therein, which constitutes the second door 20, is referred to as a second panel assembly 30. In addition, a door body 40 on which the second panel assembly 30 is mounted can be referred to as a second door body.

The description of the second door 20, the second panel assembly 30 and the second door body 40 refers to the previously described portion.

The first door 13 of the first refrigerator 1 can be replaced with the second door 20.

The second door 20 may be provided in a number corresponding to that of the first door 13. In addition, the second door 20 may be provided in a shape corresponding to that of the first door 13.

For example, the second door 20 may include a pair of refrigerating compartment doors 21 for opening and closing the refrigerating compartment 11 and a pair of freezing compartment door 22 for opening and closing the freezing compartment 12.

In addition, when the first door 13 is rotatably mounted on the cabinet 10, the second door 20 can also be rotatably mounted on the cabinet 10. In addition, when the first door 13 is configured to be pulled in and out of the cabinet 10 in a drawer-like manner, the second door 20 can also be pulled in and out of the cabinet 10 in a drawer-like manner.

Alternatively, in some cases, the door upgrade kit 5 may be composed of only a panel assembly 30 equipped with the lighting device 36. For example, the first door body 17 equipped in the first refrigerator 1 may be formed as a door body 17 having the same shape as the second door body 40. In this case, after only the first panel assembly 16 is separated from the first door 13, the second panel assembly 30 may be mounted on the first body 17.

The door upgrade kit 5 includes an electric wire 51 for supplying power to the lighting device 36. In addition, the door upgrade kit 5 may further include a signal line for controlling the lighting device 36.

In addition, the door upgrade kit 5 may include a main controller 52. The main controller 52 constituting the door upgrade kit 5 is defined as a second main controller 52.

The main controller 52 can be mounted on the upper surface of the cabinet 10. The main controller 52 can be replaced with the first main controller 19 provided in the first refrigerator 1.

The second main controller 52 can control the lighting device 36 so that the front surface of the door 20 glows in a color selected by the user. In detail, the second main controller 52 can receive color information set by the user from the remote device. Then, the lighting device 36 can be controlled so that the second door implements the color set by the user.

At this time, the second main controller 52 may also transmit the color information selected by the user to the LED controller 53 described later.

In addition, the second main controller 52 can receive a user's voice command processed by the voice module 54 and control a specific operation of the refrigerator. For example, the operation of the lighting device 36 can be controlled according to the user's voice command. Alternatively, the operation of the speaker 62 can be controlled according to the user's voice command.

The second main controller 52 can be disposed at a position corresponding to the first main controller 19. In other words, by replacing the first main controller 19 with the second main controller 52, the operation of the lighting device 36 can be controlled. In addition, a control operation that could not be implemented in the first refrigerator 1 can be implemented by the second main controller 52.

Meanwhile, the electric wires included in the door upgrade kit 5 can be connected to the lighting device 36 and the second main controller 52 to supply power to the lighting device 36.

Additionally, the signal line configured in the door upgrade kit 5 can be connected to the second main controller 52 and the LED controller 53.

In addition, in order to supply power to the second door 20, the door upgrade kit 5 includes a cover assembly 55. The cover assembly 55 constituting the door upgrade kit 5 may also be referred to as a second cover assembly 55.

The second door 20 may have a structure that is rotatably connected to the cabinet 10 by a hinge device. In particular, the upper door 21 may be rotatably connected to the cabinet 10 by a hinge device.

The cover assembly 55 includes a hinge cover 56 that covers components including hinges disposed therein. The hinge cover 56 can be positioned at the upper end of the cabinet 10 and the door 21 and can have a structure exposed to the outside.

This hinge cover 56 may be formed with a structure capable of connecting a power line and a signal line to the lighting device 36. In detail, it may be configured so as to guide a power line to the lighting device 36 through a hinge hole formed in the hinge device.

The hinge cover 56 provided in the door upgrade kit 5 may be referred to as a second hinge cover.

The second hinge cover 56 can be replaced with the hinge cover 56 provided in the first refrigerator 1, so that a power line supplying power to the lighting device 36 can be connected to the second main controller 52 and the lighting device 36.

In addition, the door upgrade kit 5 includes an LED controller 53 that controls the light sources of the lighting device 36. The position where the LED controller 53 is mounted is not limited, but for example, it may be disposed inside the hinge cover 56.

Accordingly, the LED controller 53 can be mounted on the cover assembly 55 and provided on the upper surface of the cabinet 10.

In addition, the cover assembly 55 may include a speaker module 57. The speaker module 57 may be provided in the hinge cover 56.

The speaker module 57 can be connected to a user's remote device via Bluetooth. When the user selects desired music through the remote device, the second main controller 52 can control the speaker module 57 to output the music selected by the user.

The speaker module 57 provided in the cover assembly 55 may also be referred to as a Bluetooth speaker. Alternatively, the Bluetooth speaker may also be referred to as a second speaker module.

In addition, the second main controller 52 can also control the intensity of the light source of the lighting device 36 to vary according to the frequency of the music selected by the user.

In this way, the cover assembly 55 may be composed of a hinge cover 56, an LED controller 53 that controls the lighting device 36, and a Bluetooth speaker 57, and some of the components may not be included as needed.

The cover assembly 55 can be mounted on the upper surface of the cabinet 10 of the first refrigerator 1. The first cover assembly 55 previously disposed on the first refrigerator 1 can be replaced with the second cover assembly 55.

The door upgrade kit 5 may further include a side cover 58. The side covers 58 may be provided as a pair on both sides of the upper surface of the cabinet 10. In addition, the side covers 58 may be connected to the hinge cover 56.

The side cover 58 may be provided with an electric wire passage hole through which electric wires are pulled in and out.

The side cover 58 can guide power lines connected to at least some of the electrical components inside the second door 20 to be connected to the main controller 52. The side cover 58 can have electrical wires connected to the electrical components inside the second door 20 disposed on the inside.

Additionally, the LED controller 53 or the main controller 52 and the lower door 22 can be electrically connected to each other by electric wires provided on the inside of the side cover 58.

The door upgrade kit 5 may further include a lower hinge 59. The lower hinge 59 allows the lower door 22 to be connected to the cabinet 10 and to be rotatably opened and closed. The lower hinge 59 includes an electric wire hole formed to allow electric wires connected to electrical components inside the door to pass through.

For example, as illustrated in FIGS. 8 and 9, an electric wire 51 connected to the LED controller 53 or the main controller 52 may be guided into the side cover 58 by an electric wire passage hole provided in the side cover 58. The electric wire 51 guided into the side cover 58 may be extended to the rear end of the cabinet 10. The electric wire 51 extended to the rear end of the cabinet 10 may be guided from top to bottom along the rear surface of the refrigerator to the lower end of the refrigerator.

In addition, the electric wire 51 extended to the lower end of the rear surface of the refrigerator can be extended across the lower surface of the refrigerator to the lower end of the front surface of the refrigerator. In addition, the electric wire 51 guided to the lower end of the front surface of the refrigerator can be electrically connected to the electrical components inside the lower door 22 through the lower hinge 59.

The door upgrade kit 5 may further include a holder 51a for fixing electric wires connected to electrical components inside the door. The holder may fix electric wires extending to the rear surface of the refrigerator or electric wires extending to the rear surface of the refrigerator.

Through this, power can be supplied to the lower door 22 equipped with the lighting device.

The side cover 58 that constitutes the door upgrade kit 5 can be referred to as a second side cover 58. In addition, the lower hinge 59 that constitutes the door upgrade kit 5 can be referred to as a second lower hinge 59.

In addition, if necessary, the first side cover 101 mounted on the first refrigerator 1 can be replaced with the second side cover 58. Alternatively, the second side cover 58 can be mounted on both sides of the upper surface of the cabinet 10 of the first refrigerator 1. In other words, the second side cover 58 is provided with the electric wire passage hole, so that the electric wire 51 connected to the electrical components inside the second door 20 can be connected to the main controller 52 or the LED controller 53.

In addition, if necessary, the first lower hinge mounted on the first refrigerator 1 can be replaced with the second lower hinge 59. The second lower hinge 59 is provided with an electric wire passage hole, so that electric wires connected to electrical components inside the second door 20 can be pulled in and out.

The door upgrade kit 5 may further include a microphone module 60.

The microphone module 60 may be provided, for example, in the upper cap decoration 43 forming the upper surface of the door 20 or in the cover assembly 55.

For example, the microphone module 60 can be detachably mounted on the upper cap decoration 43. The downwardly recessed accommodation part can be formed in the cap decoration 43. In addition, the upper cap decoration 43 may be equipped with a door cover 46 that shields the open upper surface of the accommodation part. The microphone module 60 may be placed in the accommodation part.

Alternatively, the microphone module 60 may be detachably mounted on the cover assembly 55.

The microphone hole may be formed in the upper cap decoration 43 or the cover assembly 55 at a position corresponding to the position where the microphone module is mounted. In addition, a microphone element may be provided at a position corresponding to the microphone hole.

The door upgrade kit 5 may further include a voice module 54. The voice module 54 may be detachably mounted on the upper cap decoration 43.

For example, the voice module 54 may be disposed inside the accommodation part of the upper cap decoration 43.

Alternatively, the voice module 54 may be detachably mounted on the cover assembly 55.

In addition, the voice module 54 can be connected to the microphone module 60. The voice module 54 can receive a voice signal input from the microphone module 60 and recognize the voice. The voice module 54 can convert the voice signal input from the microphone module and transmit it to a remote server. In addition, the server can receive the voice signal, analyze the voice signal, and determine a voice command accordingly.

For example, a user can command the lighting device to turn on/off by voice. The microphone module 60 can receive the user's voice, and the voice module 54 can analyze the voice signal input from the microphone module. Then, the main controller 52 can control the LED controller 53 according to the analyzed voice signal, thereby controlling the lighting device to turn on/off. In this way, the operation of the lighting device can be controlled according to the user's voice command.

Additionally, the user can command the Bluetooth speaker to turn on/off by voice, and the main control part can control the operation of the Bluetooth speaker according to the user's voice command.

In addition, the door upgrade kit 5 may further include a third speaker. The third speaker may output information that can be output as sound, such as information on the operating status of the refrigerator or information requested by the user.

The door upgrade kit 5 may further include a user detection device 63. The user detection device 63 is equipped with a proximity sensor and can detect the user's movement.

The user detection device 63 may be provided on the second door 20.

The main controller 52 can control the lighting device 36 to operate so that the front surface of the door 20 glows in a set color when the user detection device 63 detects that the user is approaching the refrigerator 2. Accordingly, when the user stands in front of the refrigerator 2, the front surface of the refrigerator 2 can glow in a set color.

The main controller 52 can control the lighting device 36 to be turned off or the intensity of light output from the lighting device 36 to be reduced compared to before when the distance between the user and the refrigerator 2 increases by the user detection device 63. Accordingly, when the user moves to a space other than the location where the refrigerator 2 is installed, the refrigerator 2 door can form an outer appearance with the color of the door panel 31 itself, or the front surface of the door can glow in the set color with reduced intensity.

The door upgrade kit 5 may further include a light sensing device 64 that detects the brightness of the environment in which the refrigerator is installed. The light sensing device 64 includes an illumination sensor and can detect the brightness of the surroundings in which the refrigerator is installed.

The main controller 52 can adjust the intensity of the light source output from the lighting device 36 when the room is determined to be dark by the light sensing device 64.

For example, when the room is dark, the main controller 52 can reduce the intensity of the light source output from the lighting device 36 to prevent glare when the user looks at the refrigerator.

Additionally, when the room is bright, the main controller 52 can increase the intensity of the light source output from the lighting device 36.

Whether the room is dark or bright can be determined by comparing the value detected by the light sensor with a preset value.

A door upgrade kit 5 according to one embodiment of the present disclosure can be configured by selecting the necessary parts according to the user's choice.

In addition, although the-described embodiment has been described using a refrigerator as an example, the door upgrade kit can also be applied to a home appliance including a cabinet forming a storage space and a door for opening and closing the cabinet.

For example, the home appliance may have an outer appearance formed by the panel assembly 30, and the outer appearance may change to a color set by the user according to the operation of the lighting device 36. The panel assembly may be expressed in various colors by light irradiated from the rear, and therefore the panel assembly 30 or the panel 31 may also be called a screen.

The home appliance may be any one of a refrigerator, an air conditioner, a dishwasher, a clothes manager, a washing machine or a cooking appliance, and each of these may have a structure like the panel assembly 30 of the embodiment of the present disclosure applied so that the color of the outer appearance of the front surface can be freely changed.

A user can purchase the door upgrade kit 5 and replace the first door 13 of an existing refrigerator with the second door 20, thereby enabling the front surface of the door to glow in a set color by the lighting device 36. Accordingly, there is an advantage in that one can access new functions by upgrading an existing home appliance at a low cost without purchasing a new home appliance.

### INDUSTRIAL APPLICABILITY

The refrigerator and refrigerator door upgrade kit according to the embodiment of the present disclosure can upgrade the outer appearance and performance of the refrigerator, and thus have high industrial applicability.

1. A refrigerator comprising:
a cabinet defining a storage space;
a door opening and closing the cabinet; and
a door upgrade kit detachably mounted to improve the performance of the door,
wherein the door upgrade kit includes:
a panel assembly mounted on the door to form an outer appearance of a front surface of the door and having a lighting device that causes the front surface of the door to glow in a set color; and
a main controller provided in the cabinet and controlling the operation of the refrigerator and the lighting device.

2. The refrigerator of claim 1,
wherein the door upgrade kit includes an LED controller that controls the light sources placed in the lighting device, and
wherein the main controller is connected to the LED controller and controls the lighting device to glow in a set color.

3. The refrigerator of claim 2,
wherein the door upgrade kit includes:
an electric wire connecting the lighting device, the main controller, and the LED controller.

4. The refrigerator of claim 3,
wherein a plurality of doors and a plurality of lighting devices are provided, and
wherein the lighting devices provided on the plurality of doors are connected to the LED controller provided as a single configuration in the cabinet by the electric wires.

5. The refrigerator of claim 4,
wherein the electric wires are disposed along an upper surface, a lower surface, and a rear surface of the cabinet, and guided to the lighting device inside the door through an upper hinge and a lower hinge connected to an upper end and a lower end of the door.

6. The refrigerator of claim 2,
wherein the door upgrade kit includes:
an electric wire transmitting power and operating signals to the lighting device; and
a cover assembly disposed on an upper surface of the cabinet, and
wherein the electric wires are guided through the cover assembly.

7. The refrigerator of claim 6,
wherein the cover assembly includes:
a hinge cover provided on the upper surface of the cabinet and shielding a hinge device that rotatably connects to the door, and
wherein the hinge cover accommodates the electric wires and the LED controller.

8. The refrigerator of claim 7,
wherein the cover assembly includes:
a side cover provided on both left and right sides of the upper surface of the cabinet and extending from a front end to a rear end of the cabinet to guide the electric wires toward the rear surface of the cabinet.

9. The refrigerator of claim 8,
wherein the side cover is connected to the hinge cover.

10. The refrigerator of claim 1,
wherein the door further includes a door body having the panel assembly detachably mounted thereon and having insulation material filled therein;
wherein the panel assembly includes:
a panel forming the outer appearance of the front surface of the door and through which light is transmitted;
a light guide plate disposed at the rear of the panel and guiding light irradiated from the lighting device toward the panel; and
a back cover forming a rear surface of the panel assembly.

11. The refrigerator of claim 1,
wherein the main controller receives color information set by the user from a remote device and controls the lighting device so that the panel glows in a color set by the user.

12. The refrigerator of claim 1,
wherein the door upgrade kit further includes a microphone module into which the user's voice is input, and
wherein the main controller turns on the lighting device or controls the intensity of the light output by voice input through the microphone module.

13. The refrigerator of claim 1,
wherein the door upgrade kit further includes a user detection device for detecting user approach; and
wherein the main controller turns on the lighting device or controls the output according to detection of the user detection device.

14. The refrigerator of claim 1,
wherein the door upgrade kit further includes a light sensing device that detects the brightness of the surrounding environment, and
wherein the main controller controls the output of the lighting device according to detection of the light sensing device.

15. The refrigerator of claim 1,
wherein the door upgrade kit includes electric wires to power and transmit signals to the lighting device;
wherein at least a part of the electric wire is guided from the upper surface of said cabinet to the rear surface of said cabinet, and
wherein the electric wire guided to the rear surface of the cabinet is guided along the lower surface of the cabinet and connected to the lighting device.

16. A door assembly kit comprising:
a panel assembly mounted on a door that opens and closes a storage space in a cabinet, forming an outer appearance of a front surface of said door and having a lighting device that illuminates in a set color;
a main controller provided in the cabinet and controlling the operation of the refrigerator and the lighting device;
an electric wire connecting the main controller and the lighting device to transmit power and operation signals; and
a cover assembly disposed in the cabinet and having the electric wires accommodated therein,
wherein the panel assembly is detachably mounted on the front surface of the door, and the controller and cover assembly are detachably mounted on an outer appearance of the cabinet, such that the front surface of the door glows in a set color.

17. The door assembly kit of claim 16,
wherein the door upgrade kit includes an LED controller that controls the light sources disposed in the lighting device, and
wherein the main controller is connected to the LED controller to control the lighting device to glow in the set color.

18. The door assembly kit of claim 17,
wherein the LED controller is provided in a single configuration in the cabinet, and
wherein the electric wire connects the lighting devices provided on each of the plurality of doors to the LED controller.

19. The door assembly kit of claim 16,
wherein the panel assembly is provided detachably on the front surface of the door,
wherein the panel assembly includes:
a panel forming the outer appearance of the front surface of the door and through which light is transmitted;
a light guide plate disposed at the rear of the panel and guiding light irradiated from the lighting device toward the panel; and
a back cover forming the rear surface of the panel assembly.

20. The door assembly kit of claim 19,
wherein the main controller receives color information set by the user from a remote device and controls the lighting device so that the panel glows in a color set by the user.
